(19) United States
(12) Patent Application Publication
(10) Pub. No.: US 2026/0146697 A1
(43) Pub. Date: May 28, 2026

(54) CONNECT FITTING

(71) Applicant: HSIU-YUN LIU, Changhua City (TW)

(72) Inventor: HSIU-YUN LIU, Changhua City (TW)

(21) Appl. No.: 19/049,515

(22) Filed: Feb. 10, 2025

(30) Foreign Application Priority Data
Nov. 25, 2024 (TW) 113212859

(51) Int. Cl. F16L 37/30

(52) U.S. Cl. CPC F16L 37/35; F16L 33/2073; F16L 37/144; F16L 37/33

(57) ABSTRACT

A connect fitting includes a first connector, a second connector, and at least one groove. The first connector is a hollow structure and has a first connecting end and a first free end. The second connector is a hollow structure and has a second connecting end and a second free end. The first connecting end and the second connecting end are detachably engaged with each other to allow communication between the first connector and the second connector. At least one groove is recessed in at least one of an inner wall of the first free end and an inner wall of the second connecting end. When a hydraulic pipe is connected to the first free end or the second free end, the groove can release compressive stress exerted on the hydraulic pipe to prevent the hydraulic pipe from deformation, cracking, or damage.

### FIELD OF INVENTION

The disclosure is related to a connect device, especially to a connect fitting.

### BACKGROUND OF THE INVENTION

For conventional bicycles, there is necessary to replace a bicycle stem depending on various road conditions. During the replacement process, a hydraulic pipe connecting a handlebar of the bicycle stem to a brake caliper of a brake system must be detached at first, and the hydraulic pipe is then reconnected after a new bicycle stem is installed. The replacement process is not only repetitive and cumbersome but also increases the risk of deformation or breakage of the hydraulic pipe due to repeated compression and reconnection.

Therefore, there is an urgent need to improve the convenience of detaching the hydraulic pipe while reducing deformation or breakage of the hydraulic pipe.

### SUMMARY OF THE INVENTION

Therefore, an object of the present invention is to provide a connect fitting to improve the convenience of detaching a hydraulic pipe and to prevent the hydraulic pipe from deformation or breakage during replacement process.

According to the present invention, a connect fitting includes a first connector, a second connector and at least one of groove.

The first connector is a hollow structure and includes a first connecting end and a first free end. The second connector is a hollow structure and includes a second connecting end and a second free end. At least one of the groove is recessed in at least one of an inner wall of the first free end or an inner wall of the second free end.

The first connecting end and the second connecting end are detachably engaged with each other to allow interconnection between the first connector and the second connector.

The first connector further includes a first outer casing, a first insertion tube and a thrust ring. The first outer casing is a hollow structure. The first insertion tube is disposed inside the first outer casing and includes a first flow passage defined through the first insertion tube and at least one of side orifice formed in a side wall of the first insertion tube and being in communication with the first flow passage. The thrust ring is sleeved around an outer surface of the first insertion tube and is movably relative to the first insertion tube to open or close the side orifice.

The second connector further includes a second outer casing, a second insertion tube and a blocking member. The second outer casing defines a second flow passage. The second insertion tube is disposed inside the second outer casing and has an inserting-flow passage defined through the second insertion tube and communicating with the second flow passage. The blocking member is positioned near the second connecting end and is movably relative to the to the second insertion tube in the second flow passage to open or close the second flow passage. When the first connecting end and the second connecting end are engaged with each other, the thrust ring is moved by the second connecting end to open the side orifice, and the blocking member is moved by the first insertion tube to open the second flow passage. As a result, the first flow passage, the side orifice, the second flow passage, and the inserting-flow passage are allowed to communicate with each other.

The first connector further includes a first annular protrusion and a thrust spring. The first annular protrusion radially protrudes from an inner wall of the first out casing. Two ends of the thrust spring respectively abut against the thrust ring and the first annular protrusion, and providing an abutting force toward the thrust ring. The second connector further includes a blocking spring having two ends respectively abutting against the blocking member and the second insertion tube, and providing an abutting force toward the blocking member.

The connect fitting further includes a locking clip. The locking clip includes a handle being arcuate and two insertion leg respectively extending from two ends of the handle. The first outer casing further includes two side holes formed in two opposite sides of the first outer casing, and the second outer casing further includes a clip slot annularly recessed in an outer surface of the second outer casing near the second connecting end. When the first connecting end and the second connecting end are engaged with each other, the two side holes are aligned with the clip slot to allow the insertion legs to be inserted into the side holes and to be positioned in the clip slot.

The at least one groove is implemented as multiple grooves. The multiple grooves are annularly recessed in an inner wall of the first outer casing near the first free end and are spaced apart from each other.

The connect fitting further includes multiple grooves. The grooves are annularly recessed in an inner wall of the second outer casing near the second free end and are spaced apart from each other.

According to the disclosure, a connect fitting includes a first connector, a second connector and at least one of groove.

The first connector is a hollow structure and includes a first connecting end, a first free end, a first outer casing being a hollow structure and a first insertion tube.

The first insertion tube is disposed inside the first outer casing and includes a first flow passage defined through the first insertion tube and at least one side orifice. The side orifice is formed in a side wall of the first insertion tube near the first connecting end and is in communication with the first flow passage.

The second connector is a hollow structure and includes a second connecting end, a second free end, a second outer casing being a hollow structure and a second insertion tube. The second insertion tube is disposed inside the second outer casing.

The groove is recessed in an inner wall of the first outer casing near the first free end.

The first connecting end and the second connecting end are detachably engaged with each other to allow communication between the first connector and the second connector.

The connect fitting includes multiple grooves. The multiple grooves are annularly recessed in the inner wall of the first outer casing near the first free end and are spaced apart from each other.

The connect fitting further includes multiple grooves. The multiple grooves are annularly recessed in an inner wall of the second outer casing near the second free end and are spaced apart from each other.

In the present invention, when a hydraulic pipe is coupled to the first free end, the hydraulic pipe is compressed by the first outer casing and the first insertion tube to make the hydraulic pipe tightly connected to the first connector, and to prevent liquid leakage. Additionally, the design of the groove can release compressive stress exerted on the hydraulic pipe, thereby the risk of cracking or damage of the hydraulic pipe during a long term of compression is reduced.

### BRIEF DESCRIPTION OF THE DRAWINGS

FIG. 1 is an exploded perspective view illustrating a preferred embodiment of a connect fitting according to the present invention;

FIG. 2 is a cross-sectional side view of the preferred embodiment of the connect fitting shown in FIG. 1;

FIG. 3 is a cross-sectional side view illustrating the usage of the connect fitting shown in FIG. 1; and

FIG. 4 is a cross-sectional side view of another embodiment of the connect fitting.

### DETAILED DESCRIPTION OF THE PREFERRED EMBODIMENTS

In order to make purposes, technical solutions, and advantages of the present invention to be clearer, the following content provides some preferred embodiments in accordance with the present invention.

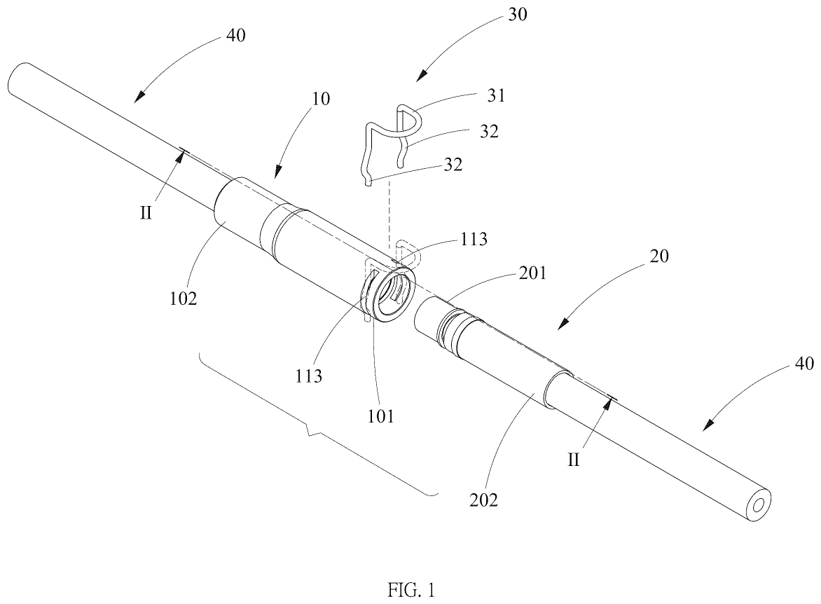

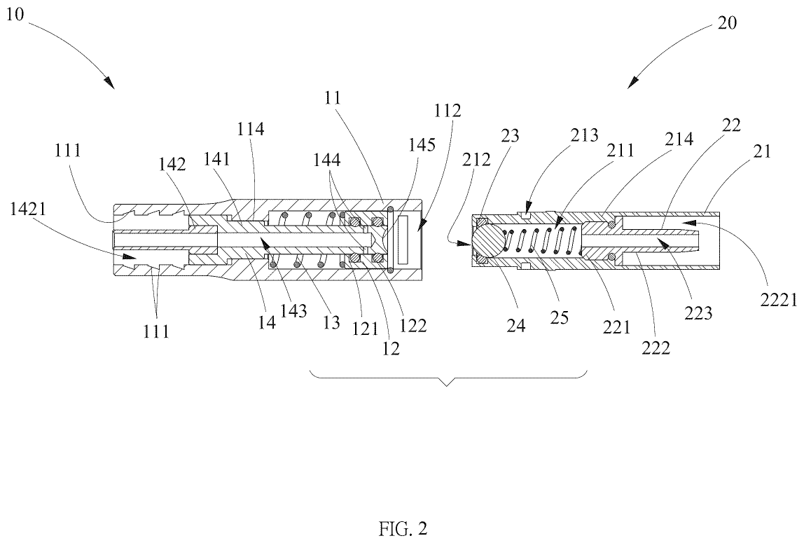

Referring to FIG. 1 and FIG. 2, a preferred embodiment of a connect fitting is disclosed. The connect fitting includes a first connector 10, a second connector 20, a locking clip 30 and at least one groove 111.

The first connector 10 extends along a longitudinal direction and is a hollow structure with two ends defined as a first connecting end 101 and a first free end 102 respectively.

The first connector 10 includes a first outer casing 11, a thrust ring 12, a thrust spring 13, and a first insertion tube 14.

The first outer casing 11 is a hollow structure extending along the longitudinal direction and includes a first pipe opening 112, two side holes 113 and a first annular protrusion 114.

In this embodiment, the connect fitting includes multiple grooves 111. The grooves 111 are annularly recessed in an inner wall of the first outer casing 11 near the first free end 102 and are spaces apart with each other.

The first pipe opening 112 is formed in the first connecting end 101 opposite to the grooves 111. The two side holes 113 are symmetrically formed in opposite sides of the first outer casing 11 near the first pipe opening 112.

The first annular protrusion 114 annularly protrudes inwardly from the inner wall of the first outer casing 11 and is positioned between the groove 111 and the first pipe opening 112.

The thrust ring 12 is an annular body and includes two annular slots 121 and two sealing rings 122. The thrust ring 12 is coaxially positioned inside the first outer casing 11 and can be moved axially between the side holes 113 and the grooves 111. The annular slots 121 are recessed in an inner wall of the thrust ring 12, and the sealing rings 122 are respectively mounted in the annular slots 121.

The thrust spring 13 is disposed inside the first outer casing 11, and two ends of the thrust spring 13 abut against the thrust ring 12 and the first annular protrusion 114 respectively. When the first connector 10 is not in use, the thrust ring 12 is positioned between the thrust spring 13 and the first pipe opening 112. Preferably, the thrust spring 13 provides an abutting force against the thrust ring 12. In this embodiment, the thrust spring 13 is a coil spring.

The first insertion tube 14 is a hollow rod-like structure extending along the longitudinal direction and is positioned inside the first outer casing 11. The first insertion tube 14 includes a first coupling section 141, a first pipe connecting section 142, a first flow passage 143, at least one side orifice 144 and a thrust face 145.

An end of the first coupling section 141 is positioned near the first pipe opening 112, and at least one part of the first coupling section 141 extends through the thrust ring 12. The first pipe connecting section 142 is positioned at an end of the first coupling section 141 opposite to the first connecting end 101 and extends towards the grooves 111. A first annular interspace 1421 is formed between the first pipe connecting section 142 and the first outer casing 11. Preferably, the first annular interspace 1421 is located a position on the inner wall of the first outer casing 11 in which the groove 111 are defined.

Preferably, the first coupling section 141 and the first pipe connecting section 142 are two separate components and can be detachably connected to each other.

The first flow passage 143 is defined through the first insertion tube 14 and extends along the first coupling section 141 and the first pipe connecting section 142. The side orifice 144 is formed in a circumferential wall of the first coupling section 141 and corresponds to a position of the thrust ring 12. The side orifice 144 communicates with the first flow passage 143. The thrust face 145 is formed on an end surface of the first insertion tube 14 near the first connecting end 101. Preferably, the thrust face 145 is a curved surface recessed in an end surface of the first insertion tube 14.

Additionally, when the first connector 10 is not in use, the side orifice 144 is covered and closed by the thrust ring 12, thereby communication between the first flow passage 143 and an interior space of the first outer casing 11 is prevented to ensure preventing leakage with the sealing rings 122.

The second connector 20 is a hollow rod-like structure extending along the longitudinal direction with two ends of the second connector 20 defined respectively as a second connecting end 201 and a second free end 202. The second connector 20 includes a second outer casing 21, a second insertion tube 22, a sealing abut part 23, a blocking member 24 and a blocking spring 25.

The second outer casing 21 is a hollow structure includes a second flow passage 211, a second pipe opening 212, a clip slot 213, and a second annular protrusion 214. The second flow passage 211 is defined through the second outer casing 21, and the second pipe opening 212 is positioned at the connecting end 201. The second insertion tube 22 is positioned inside the second flow passage 211 near the second free end 202.

The clip slot 213 is annularly recessed in an outer surface of the second outer casing 21 near the second pipe opening 212. The second annular protrusion 214 annularly protrudes inwardly from the inner wall of the second outer casing 21.

In another embodiment, the second connector 20 may include two clip slots 213 recessed in opposite sides of the second outer casing 21 and corresponding to the side holes 113 of the first connector 10.

The second insertion tube 22 is a hollow tubular structure and is coaxially positioned within the second outer casing 21, is located at one side of the second annular protrusion 214 near the second free end 202. The second insertion tube 22 includes a second coupling section 221, a second pipe connecting section 222, and an inserting-flow passage 223. The second coupling section 221 and the second pipe connecting section 222 are connected to each other, and the second pipe connecting section 222 is positioned adjacent to the second free end 202. A diameter of the second coupling section 221 is larger than a diameter of the second pipe connecting section 222. The second coupling section 221 is positioned within the second flow passage 211 with corresponding to the second pipe opening 212 and abuts against the second annular protrusion 214. A second annular interspace 2221 is formed between the second pipe connecting section 222 and the second outer casing 21. The inserting-flow passage 223 is formed through the second insertion tube 22 and extends along the second coupling section 221 and the second pipe connecting section 222. The inserting-flow passage 223 communicates with the second flow passage 211.

The sealing ring 23 is positioned in the second outer casing 21 near the second pipe opening 212. The blocking member 24 is a spherical body and is located in the second flow passage 211. At least one part of the blocking member 24 abuts against the sealing ring 23. The blocking member 24 can move axially between the second pipe opening 212 and the second insertion tube 22.

The blocking spring 25 is positioned between the second insertion tube 22 and the blocking member 24. Two ends of the blocking spring 25 abut against the second coupling section 221 and the blocking member 24 respectively to provide an abutting force to the blocking member 24. In this embodiment, the blocking spring 25 is a coil spring.

The locking clip 30 includes a handle 31 and two insertion legs 32. The handle is arcuate. The two insertion legs 32 extend from the ends of the handle 31 respectively.

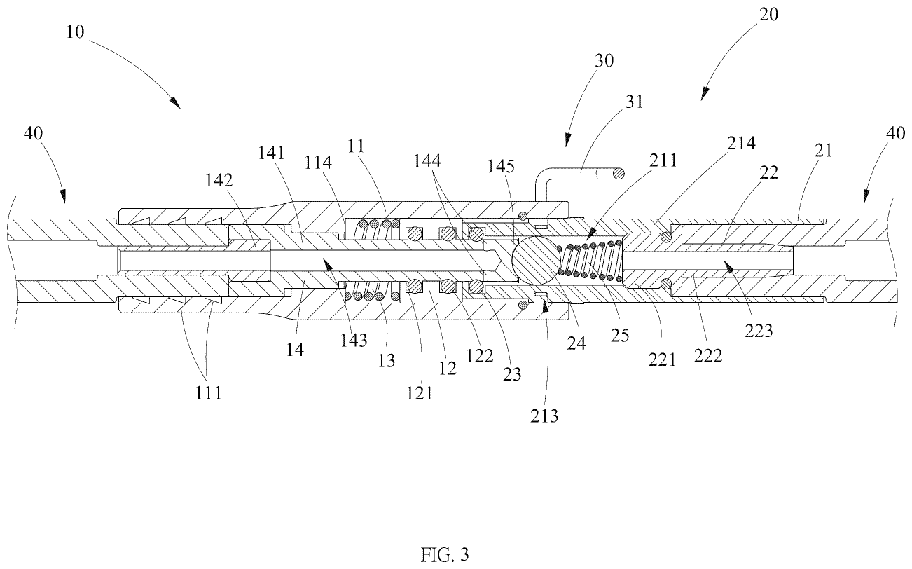

Referring to FIG. 2 and FIG. 3, when the connect fitting is in use, the second connector 20 is engaged with the first connector 10 via alignment of the second pipe opening 212 and first pipe opening 112. In this state shown in FIG. 3, the second connecting end 201 abuts against the thrust ring 12, and the blocking member 24 abuts against the thrust face 145. When the second connector 20 applies pressure toward the first connector 10, the thrust ring 12 is moved by the second connector 20 toward the first annular protrusion 114, and the thrust spring 13 is compressed. Simultaneously, the first insertion tube 14 exerts pressure to the blocking member 24, and the blocking spring 25 is compressed. Accordingly, the blocking member 24 is moved toward the second insertion tube 22 util the clip slot 213 aligns with the side holes 113. At this point, the two insertion legs 32 can be inserted into the side holes 113 and can be positioned within the clip slot 213, so as to securely lock the first connector 10 and the second connector 20 together.

When the first connector 10 and the second connector 20 are engaged with each other, the side orifice 144 is exposed within the first outer casing 11 due to the displacement of the thrust ring 12 to allow the first flow passage 143 to communicate with the second flow passage 211.

When the connect fitting is in use, two connecting pipes 40, such as hydraulic pipes, are respectively connected to the first pipe connecting section 142 and the second pipe connecting section 222 and correspond respectively to the first free end 102 and the second free end 202. An outer diameter of the connecting pipes 40 is not smaller than an inner diameter of the first outer casing 11 and the second outer casing 21.

During engagement of the connecting pipes 40 with the first free end 102 and the second free end 202, one of the connecting pipes 40 is pressed into the first annular interspace 1421 along an outer wall of the first pipe connecting section 142. At this point, the connecting pipe 40 contacts to the grooves 111, and the first flow passage 143 communicates with the connecting pipe 40. Similarly, the other connecting pipe 40 is pressed into the second annular interspace 2221 along an outer wall of the second pipe connecting section 222 to allow the second flow passage 211 to communicate with the other connecting pipe 40.

Notably, when the connecting pipe 40 is connected to the first connector 10, an outer surface and an inner surface of the connecting pipe 40 are compressed by the first outer casing 11 and the first insertion tube 14 respectively to ensure that the connecting pipe 40 is engaged tightly with the first free end 102 to prevent liquid leakage. The design of the grooves 111 allows to release compressive stress exerted on the connecting pipe 40 to reduce the risk of cracking or damage during a long term of compression.

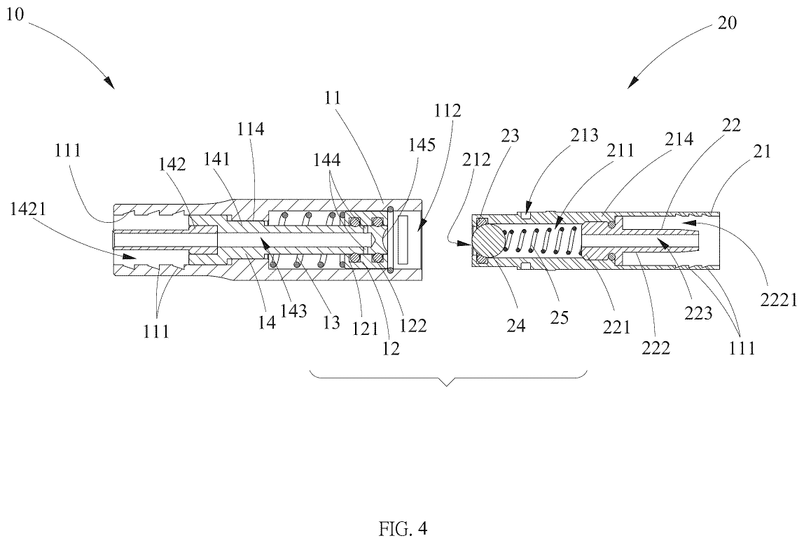

The grooves 111 are not limited to being positioned at the first outer casing 11. Referring to FIG. 4, the grooves 111 can also be formed in the second outer casing 21 near the second free end 202. Any configuration that facilitates the release of structural stress caused by compression to the connecting pipes 40 is encompassed within the scope of the present invention.

What is claimed is:

1. A connect fitting comprising:
a first connector being a hollow structure and comprising a first connecting end and a first free end;
a second connector being a hollow structure and comprising a second connecting end and a second free end; and
at least one groove recessed in at least one of an inner wall of the first free end or an inner wall of the second free end,
wherein the first connecting end and the second connecting end are detachably engaged with each other to allow interconnection between the first connector and the second connector.

2. The connect fitting as claimed in claim 1, wherein the first connector further comprises:
a first outer casing being a hollow structure,
a first insertion tube disposed inside the first outer casing and including:
a first flow passage defined through the first insertion tube, and
at least one side orifice formed in a side wall of the first insertion tube and being in communication with the first flow passage,
a thrust ring sleeved around an outer surface of the first insertion tube and being movably relative to the first insertion tube to open or close the side orifice; and
the second connector further comprises:
a second outer casing defining a second flow passage,
a second insertion tube disposed inside the second outer casing and having an inserting-flow passage defined through the second insertion tube and communicating with the second flow passage,
a blocking member positioned near the second connecting end and being movably relative to the to the second insertion tube within the second flow passage to open or close the second flow passage,
wherein, when the first connecting end and the second connecting end are engaged with each other, the thrust ring is moved by the second connecting end to open the side orifice, and the blocking member is moved by the first insertion tube to open the second flow passage, so that the first flow passage, the side orifice, the second flow passage, and the inserting-flow passage are allowed to communicate with each other.

3. The connect fitting as claimed in claim 2, wherein the first connector further comprises:
a first annular protrusion radially protruding from an inner wall of the first out casing,
a thrust spring having two ends respectively abutting against the thrust ring and the first annular protrusion, and providing an abutting force toward the thrust ring
the second connector further comprising a blocking spring having two ends respectively abutting against the blocking member and the second insertion tube, and providing an abutting force toward the blocking member.

4. The connect fitting as claimed in claim 3 further comprising:
a locking clip comprising
a handle being arcuate, and
two insertion leg respectively extending from two ends of the handle;
wherein, the first outer casing further comprises two side holes formed in two opposite sides of the first outer casing, and the second outer casing further comprises a clip slot annularly recessed in an outer surface of the second outer casing near the second connecting end;
when the first connecting end and the second connecting end are engaged with each other, the two side holes are aligned with the clip slot to allow the insertion legs to be inserted into the side holes and to be positioned in the clip slot.

5. The connect fitting as claimed in claim 2, wherein the at least one groove is implemented as several multiple grooves annularly recessed in an inner wall of the first outer casing near the first free end and being spaced apart from each other.

6. The connect fitting as claimed in claim 2, wherein the at least one groove is implemented as several multiple grooves annularly recessed in an inner wall of the second outer casing near the second free end and being spaced apart from each other.

7. The connect fitting as claimed in claim 5 further comprising multiple grooves annularly recessed in an inner wall of the second outer casing near the second free end and being spaced apart from each other.

8. A connect fitting comprising:
a first connector being a hollow structure and comprising:
a first connecting end,
a first free end,
a first outer casing being a hollow structure, and
a first insertion tube disposed inside the first outer casing and including:
a first flow passage defined through the first insertion tube,
at least one side orifice formed in a side wall of the first insertion tube near the first connecting end and being in communication with the first flow passage;
a second connector being a hollow structure and comprising:
a second connecting end,
a second free end,
a second outer casing being a hollow structure,
a second insertion tube disposed inside the second outer casing; and
at least one of groove recessed in an inner wall of the first outer casing near the first free end,
wherein, the first connecting end and the second connecting end are detachably engaged with each other to allow interconnection between the first connector and the second connector.

9. The connect fitting as claimed in claim 8, wherein the at least one groove is implemented as several multiple grooves annularly recessed in the inner wall of the first outer casing and being spaced apart from each other.

10. The connect fitting as claimed in claim 8 further comprising multiple grooves annularly recessed in an inner wall of the second outer casing near the second free end and being spaced apart from each other.
